(19) United States
(12) Patent Application Publication
(10) Pub. No.: US 2010/0085354 A1
(43) Pub. Date: Apr. 8, 2010

(54) MULTI-MEDIA PROCESSOR, HAND-HELD ELECTRICAL COMMUNICATION DEVICE AND IMAGE PROCESSING METHOD THEREOF

(75) Inventors: Chung-Ching TSAI, Hsinchu County (TW); Chin-I Huang, Yilan County (TW)

Correspondence Address: RABIN & Berdo, PC, 1101 14TH STREET, NW, SUITE 500, WASHINGTON, DC, 20005, US

(73) Assignee: Alpha Imaging Technology Corp., Hsinchu County (TW)

(21) Appl. No.: 12/572,443

(22) Filed: Oct. 2, 2009

(30) Foreign Application Priority Data
Oct. 3, 2008 (TW) 097138049

(51) Int. Cl. G06T 15/00; G06T 1/00; G09G 5/00

(52) U.S. Cl. 345/419; 345/522; 345/660

(57) ABSTRACT

A hand-held electrical communication device including a host processor, a multi-media processor and a display unit is provided. The host processor is used for outputting a graphic rendering command. The multi-media processor is used for adjusting an original image frame as an adjusted image frame, processing a dynamic image of the adjusted image frame as a processed dynamic image frame, processing a static image of the adjusted image frame as a processed static image frame, or drawing a graphic frame according to the graphic rendering command. The multi-media processor scales the adjusted image frame, the processed dynamic image frame, the processed static image frame or the graphic frame. The display unit is controlled by the host processor to display the scaled adjusted image frame, the scaled processed dynamic image frame, the scaled processed static image frame or the scaled graphic frame.

This application claims the benefit of Taiwan application Serial No. 97138049, filed Oct. 3, 2008, the subject matter of which is incorporated herein by reference.

### BACKGROUND OF THE INVENTION

1. Field of the Invention

The invention relates in general to a multi-media processor, a hand-held electrical communication device and an image processing method thereof, and more particularly to a multi-media processor with graphic function, a hand-held electrical communication device and an image processing method thereof.

2. Description of the Related Art

Referring to FIG. 1, a conventional mobile phone is shown. The mobile phone 100 includes an optical sensor 110, an image signal processing chip 120, a baseband chip 130 and a liquid crystal panel 140. The optical sensor 110 is coupled to the image signal processing chip 120 via a Consultative Committee of International Radio (CCIR) bus, and the image signal processing chip 120 is coupled to the baseband chip 130 via another CCIR bus, wherein both of the CCIR buses are uni-directional buses. The optical sensor 110 is used for generating multiple original image frames being raw image frames. The optical sensor 110 transmits the original image frames to the image signal processing chip 120.

Referring to FIG. 2, a block diagram of a conventional image signal processing chip is shown. The image signal processing chip 120 includes a CCIR receiver 121, an image processing engine 122, a scaling engine 123 and a CCIR transmitter 124. The image signal processing chip 120 receives multiple original image frames from the optical sensor 110 via the CCIR receiver 121. The image processing engine 122 performs various procedures of image processing such as automatic exposing, automatic white balance or automatic focusing on the original image frames to obtain multiple adjusted image frames. The scaling engine 123 scales these adjusted image frames according to the resolution of the liquid crystal panel 140 to obtain multiple scaled image frames. The CCIR transmitter 124 outputs these scaled image frames to the baseband chip 130, which displays these scaled image frames on the liquid crystal panel 140.

However, as the functions of the mobile phone 100 become more versatile, graphic function has become one of the accessory functions of the mobile phone 100. Thus, the baseband chip 130 is used for performing graphic function, or extra circuit elements are disposed on the baseband chip 130 by way of an external memory interface (EMI) or a memory mapped peripherals (MMP) to enable graphic function. By doing this, the huge and complicated software architecture of the baseband chip 130, that is, the main-machine interface (MMI), needs to be changed, extra cost will incur and such change is not suitable to the integrated type architecture.

### SUMMARY OF THE INVENTION

The invention is directed to a multi-media processor, a hand-held electrical communication device and an image processing method using the same. The multi-media processor achieves the graphic function and the graphic frames are transmitted to the host processor via a bus capable of transmitting a large volume of data, so that the graphic frames can be displayed on the display unit without having to change the software architecture of the host processor.

According to a first aspect of the present invention, a multi-media processor including an image processing engine, a dynamic image processing engine, a static image processing engine, a host controller, a graphic engine and a scaling engine is provided. The image processing engine is used for adjusting an original image frame outputting from an image sensing unit as an adjusted image frame. The dynamic image processing engine is used for processing a dynamic image of the adjusted image frame to obtain a processed dynamic image frame. The static image processing engine is used for processing a static image of the adjusted image frame to obtain a processed static image frame. The host controller is used for receiving a graphic rendering command from a host processor via a first bus. The graphic engine is used for drawing a graphic frame according to the graphic rendering command. The scaling engine is used for respectively scaling at least one of the adjusted image frame, the processed dynamic image frame, the processed static image frame, and the graphic frame, and outputting at least one of the scaled adjusted image frame, the scaled processed dynamic image frame, the scaled processed static image frame, and the scaled graphic frame to the host processor via a second bus.

According to a second aspect of the present invention, a hand-held electrical communication device including a host processor, a multi-media processor and a display unit is provided. The host processor is used for outputting a graphic rendering command. The multi-media processor electrically connected to the host processor is used for adjusting an original image frame as an adjusted image frame, processing a dynamic image of the adjusted image frame as a processed dynamic image frame, processing a static image of the adjusted image frame as a processed static image frame, or drawing a graphic frame according to the graphic rendering command, and scaling the adjusted image frame, the processed dynamic image frame, the processed static image frame or the graphic frame. The display unit is controlled by the host processor to display the scaled adjusted image frame, the scaled processed dynamic image frame, the scaled processed static image frame or the scaled graphic frame.

According to a third aspect of the present invention, an image processing method for a hand-held electrical communication device is provided. The hand-held electrical communication device includes a host processor, a multi-media processor and a display unit. The image processing method includes the following steps. The host processor is used for outputting a graphic rendering command. The multi-media processor is used for adjusting an original image frame as an adjusted image frame, processing a dynamic image of the adjusted image frame as a processed dynamic image frame, processing a static image of the adjusted image frame as a processed static image frame, or drawing a graphic frame according to the graphic rendering command, and scaling the adjusted image frame, the processed dynamic image frame, the processed static image frame or the graphic frame. The host processor is used for receiving and displaying the scaled adjusted image frame, the scaled processed dynamic image frame, the scaled processed static image frame or the scaled graphic frame on the display unit.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) shows a conventional mobile phone;

FIG. 2 (Prior Art) shows a block diagram of a conventional image signal processing chip;

FIG. 3 shows a block diagram of a hand-held electrical communication device according to a preferred embodiment of the invention; and

FIG. 4 shows a block diagram of a multi-media processor according to a preferred embodiment of the invention.

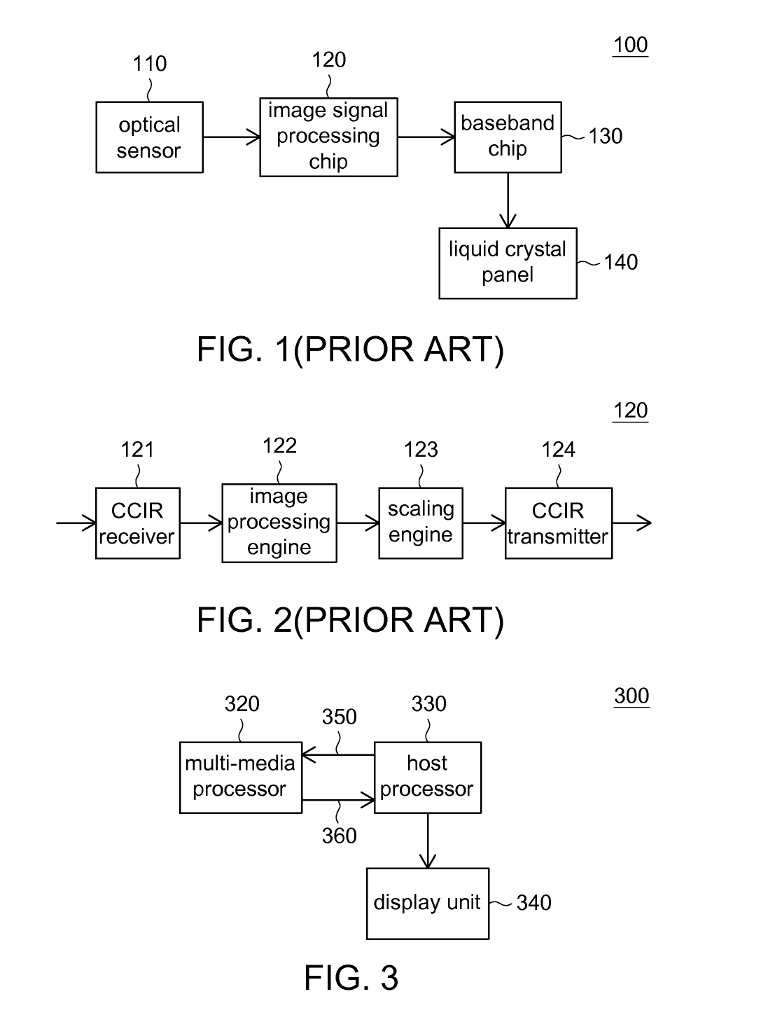

### DETAILED DESCRIPTION OF THE INVENTION

The invention provides a hand-held electrical communication device and an image processing method using the same. The graphic engine disposed in the multi-media processor enables graphic function and graphic frames are transmitted to the host processor by the existing bus capable of transmitting a large volume of data, so that the graphic frames can be displayed on the display unit without having to change the software architecture of the host processor.

Referring to FIG. 3, a block diagram of a hand-held electrical communication device according to a preferred embodiment of the invention is shown. The hand-held electrical communication device 300 is, for example, a mobile phone which includes a multi-media processor 320, a host processor 330 and a display unit 340. The host processor 330 is a baseband chip or an application processor for example.

The multi-media processor 320 communicates with the host processor 330 via a uni-directional second bus 360 which can be a Consultative Committee of International Radio (CCIR) parallel bus, a standard mobile imaging architecture (SMIA) serial bus or a mobile industry processor interface (MIPI) serial bus. The second bus 360 is capable of transmitting a large volume of data. Besides, the host processor 330 communicates with the multi-media processor 320 via a first bus 350, which can be any serial or parallel bus and is not subjected to any restrictions.

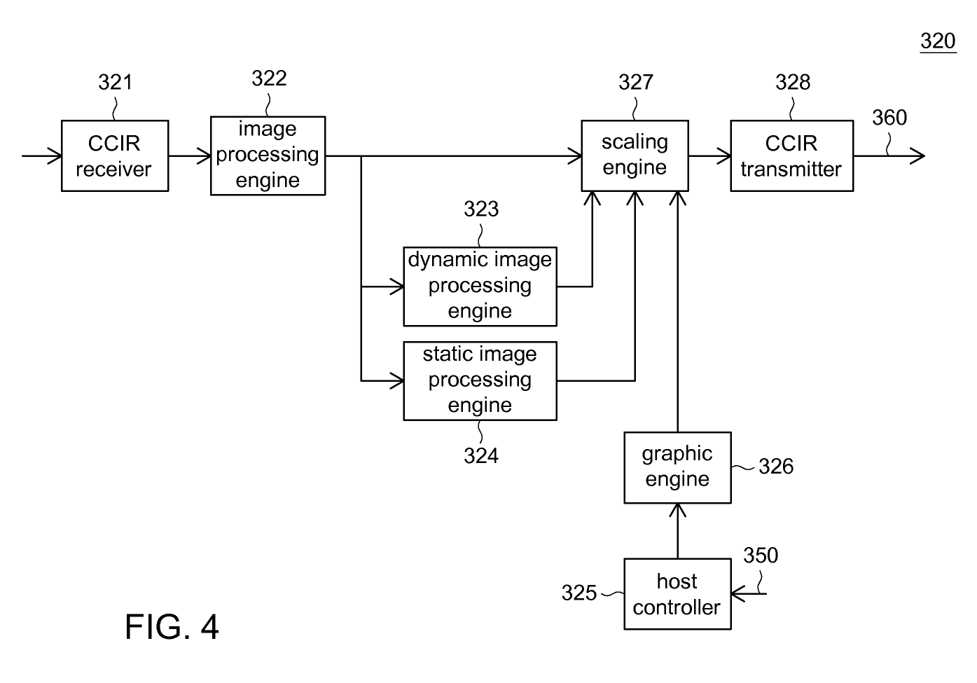

Referring to FIG. 4, a block diagram of a multi-media processor according to a preferred embodiment of the invention is shown. The multi-media processor 320 includes a CCIR receiver 321, an image processing engine 322, a dynamic image processing engine 323, a static image processing engine 324, a host controller 325, a graphic engine 326, a scaling engine 327 and a CCIR transmitter 328. The multi-media processor 320 substantially receives multiple original image frames from an image sensing unit (not illustrated) via the CCIR receiver 321. The image sensing unit is, for example, a complementary metal oxide semiconductor (CMOS) sensor or a charge-coupled device (CCD) sensor for generating multiple original image frames being raw image frames. The original image frames are static images for instance.

The image processing engine 322 performs image processing such as automatic exposing, automatic white balance or automatic focusing on a received original image frame to obtain an adjusted image frame. The dynamic image processing engine 323 is used for processing a dynamic image of the adjusted image frame to obtain a processed dynamic image frame. The dynamic image can be stored in the storage unit or outputted from the host processor 330. The static image processing engine 324 is used for processing a static image of the adjusted image frame to obtain a processed static image frame. The static image can be stored in the storage unit or outputted from the host processor 330.

When the hand-held electrical communication device 300 performs the graphic function, the host processor 330 outputs a graphic rendering command to control the multi-media processor 320 to perform drawing. The multi-media processor 320 uses the host controller 325 to receive the graphic rendering command from the host processor 330 via the first bus 350. The graphic engine 326 performs the graphic function according to the graphic rendering command to obtain a graphic frame. The graphic engine 326 can be a 3-D graphic engine or a vector graphic engine, and is not subjected to any specific restriction. The 3-D graphic engine and the vector graphic engine can co-exist.

The scaling engine 327 respectively scales at least one of the adjusted image frame, the processed dynamic image frame, the processed static image frame, and the graphic frame according to the resolution of the display unit 340, wherein these scaled frames are YUV/RGB image frames for example. The CCIR transmitter 328 outputs at least one of the scaled adjusted image frame, the scaled processed dynamic image frame, the scaled processed static image frame, and the scaled graphic frame to the host processor 330 via the second bus 360. The host processor 330 displays these scaled frames on the display unit 340. Besides, the multi-media processor 320 may further include a combining unit (not illustrated). The combining unit can be placed before the scaling engine 327 for combining the adjusted image frame, the processed dynamic image frame, the processed static image frame, or the graphic frame with each other first before these frames are scaled by the scaling engine 327. The combining unit can also be placed after the scaling engine 327 for combining the scaled multiple frames.

Afterwards, the multi-media processor 320 uses the CCIR transmitter 328 to output the scaled adjusted image frame, the scaled processed dynamic image frame, the scaled processed static image frame, or the scaled graphic frame to the host processor 330 via the second bus 360 capable of transmitting a large volume of data. The host processor 330 displays these scaled frames on the display unit 340.

According to the hand-held electrical communication device 300 disclosed in the preferred embodiment of the invention, the graphic engine 326 newly disposed in the multi-media processor 320 is used for performing the graphic function, and the existing second bus 360 capable of transmitting a large volume of data is used for transmitting the graphic frames to the host processor 330, so that the host processor 330 is able to display the graphic frames on the display unit 340. Thus, the graphic function is integrated in the hand-held electrical communication device 300 and there is no need to change the software architecture of the host processor 330, that is, the main-machine interface (MMI).

Also, the invention provides an image processing method for a hand-held electrical communication device. The hand-held electrical communication device includes a host processor, a multi-media processor and a display unit. The image processing method includes the following steps. The host processor is used for outputting a graphic rendering command. The multi-media processor is used for adjusting an original image frame as an adjusted image frame, processing a dynamic image of the adjusted image frame as a processed dynamic image frame, processing a static image of the adjusted image frame as a processed static image frame, or drawing a graphic frame according to the graphic rendering command, and scaling the adjusted image frame, the processed dynamic image frame, the processed static image frame or the graphic frame. The host processor is used for receiving and displaying the scaled adjusted image frame, the scaled processed dynamic image frame, the scaled processed static image frame or the scaled graphic frame on the display unit. The principles of the image processing method for a hand-held electrical communication device are disclosed in the elaboration of the hand-held electrical communication device 300, and are not repeated here again.

According to the multi-media processor disclosed in the above embodiments of the invention, the hand-held electrical communication device and the image processing method thereof achieve the graphic function by a graphic engine disposed in the multi-media processor, and the graphic frames are transmitted to the host processor by the existing bus capable of transmitting a large volume of data without having to change the software architecture of the host processor so that the host processor displays the graphic frame on the display unit, and the graphic function is integrated in the hand-held electrical communication device.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A multi-media processor, comprising:
an image processing engine used for adjusting an original image frame coming from an image sensing unit as an adjusted image frame;
a dynamic image processing engine used for processing a dynamic image of the adjusted image frame to obtain a processed dynamic image frame;
a static image processing engine used for processing a static image of the adjusted image frame to obtain a processed static image frame;
a host controller used for receiving a graphic rendering command from a host processor via a first bus;
a graphic engine used for drawing a graphic frame according to the graphic rendering command; and
a scaling engine used for respectively scaling at least one of the adjusted image frame, the processed dynamic image frame, the processed static image frame, and the graphic frame, and outputting at least one of the scaled adjusted image frame, the scaled processed dynamic image frame, the scaled processed static image frame, and the scaled graphic frame to the host processor via a second bus.

2. The multi-media processor according to claim 1, wherein the second bus is a Consultative Committee of International Radio (CCIR) parallel bus, a standard mobile imaging architecture (SMIA) serial bus or a mobile industry processor interface (MIPI) serial bus.

3. The multi-media processor according to claim 1, wherein the dynamic image or the static image comes from the host processor or a storage unit.

4. The multi-media processor according to claim 1, wherein the graphic engine is a 3-D graphic engine or a vector graphic engine.

5. A hand-held electrical communication device, comprising:
a host processor used for outputting a graphic rendering command;
a multi-media processor electrically connected to the host processor for adjusting an original image frame as an adjusted image frame, processing a dynamic image of the adjusted image frame as a processed dynamic image frame, processing a static image of the adjusted image frame as a processed static image frame, or drawing a graphic frame according to the graphic rendering command, and scaling the adjusted image frame, the processed dynamic image frame, the processed static image frame or the graphic frame; and
a display unit controlled by the host processor to display the scaled adjusted image frame, the scaled processed dynamic image frame, the scaled processed static image frame or the scaled graphic frame.

6. The multi-media processor according to claim 5, further comprising a first bus and a second bus, wherein the host processor outputs the graphic rendering command to the multi-media processor via the first bus, and the multi-media processor outputs the scaled adjusted image frame, the scaled processed dynamic image frame, the scaled processed static image frame or the scaled graphic frame to the host processor via the second bus.

7. The hand-held electrical communication device according to claim 6, wherein the second bus is a CCIR parallel bus, an SMIA serial bus or an MIPI serial bus.

8. The multi-media processor according to claim 5, wherein the host processor is a baseband chip or an application processor.

9. The multi-media processor according to claim 5, further comprising an image sensing unit used for generating the original image frame.

10. The multi-media processor according to claim 5, wherein the dynamic image or the static image comes from the host processor or a storage unit.

11. The multi-media processor according to claim 5, wherein the multi-media processor comprises:
an image processing engine used for adjusting the original image frame as the adjusted image frame;
a dynamic image processing engine used for processing the dynamic image to obtain the processed dynamic image frame;
a static image processing engine used for processing the static image to obtain the processed static image frame;
a host controller used for receiving the graphic rendering command from the host processor;
a graphic engine used for drawing the graphic frame according to the graphic rendering command; and
a scaling engine used for scaling the adjusted image frame, the processed dynamic image frame, the processed static image frame or the graphic frame.

12. The hand-held electrical communication device according to claim 11, wherein the graphic engine is a 3-D graphic engine or a vector graphic engine.

13. An image processing method for a hand-held electrical communication device, wherein the hand-held electrical communication device comprises a host processor, a multi-media processor and a display unit, and the image processing method comprises:
utilizing the host processor to output a graphic rendering command;
utilizing the multi-media processor to adjust an original image frame as an adjusted image frame, process a dynamic image of the adjusted image frame as a processed dynamic image frame, process a static image of the adjusted image frame as a processed static image frame, or draw a graphic frame according to the graphic rendering command, and to scale the adjusted image frame, the processed dynamic image frame, the processed static image frame or the graphic frame; and
utilizing the host processor to receive and display the scaled adjusted image frame, the scaled processed dynamic image frame, the scaled processed static image frame or the scaled graphic frame on the display unit.

14. The image processing method for a hand-held electrical communication device according to claim 13, wherein the hand-held electrical communication device further comprises a first bus and a second bus, and the image processing method further comprises:
utilizing the host processor to output the graphic rendering command to the multi-media processor via the first bus; and
utilizing the multi-media processor to output the scaled adjusted image frame, the scaled processed dynamic image frame, the scaled processed static image frame or the scaled graphic frame to the host processor via the second bus.

15. The image processing method for a hand-held electrical communication device according to claim 14, wherein the second bus is a CCIR parallel bus, an SMIA serial bus or an MIPI serial bus.

16. The image processing method for a hand-held electrical communication device according to claim 13, wherein the host processor is a baseband chip or an application processor.

17. The image processing method for a hand-held electrical communication device according to claim 13, wherein the hand-held electrical communication device further comprises an image sensing unit, and the image processing method further comprises:
utilizing the image sensing unit to generate the original image frame.

18. The image processing method for a hand-held electrical communication device according to claim 13, wherein the dynamic image or the static image comes from the host processor or a storage unit.

19. The image processing method for a hand-held electrical communication device according to claim 13, wherein the multi-media processor comprises an image processing engine, a dynamic image processing engine, a static image processing engine, a host controller, a graphic engine and a scaling engine, and the image processing method further comprises:
utilizing the image processing engine to adjust the original image frame as the adjusted image frame;
utilizing the dynamic image processing engine to process the dynamic image to obtain the processed dynamic image frame;
utilizing the static image processing engine to process the static image to obtain the processed static image frame;
utilizing the host controller to receive the graphic rendering command from the host processor;
utilizing the graphic engine to draw the graphic frame according to the graphic rendering command; and
utilizing the scaling engine to scale the adjusted image frame, the processed dynamic image frame, the processed static image frame or the graphic frame.

20. The image processing method for a hand-held electrical communication device according to claim 19, wherein the graphic engine is a 3-D graphic engine or a vector graphic engine.
